(19) United States
(12) Patent Application Publication
(10) Pub. No.: US 2017/0173531 A1
(43) Pub. Date: Jun. 22, 2017

(54) METHODS AND SYSTEMS FOR TOTAL ORGANIC CARBON REMOVAL

(71) Applicant: DCL INTERNATIONAL INC., Concord (CA)

(72) Inventors: Shazam WILLIAMS, Toronto (CA); Linjie HU, Vaughn (CA)

(21) Appl. No.: 15/327,618

(22) PCT Filed: Jul. 17, 2015
(86) PCT No.: PCT/CA2015/050667

§ 371 Date: Jan. 19, 2017

Related U.S. Application Data
(60) Provisional application No. 62/025,767, filed on Jul. 17, 2014.

(51) Int. Cl. B01D 53/94; B01J 23/44; F01N 3/08; B01J 20/06; B01J 20/04; B01D 53/52; B01J 23/42

(52) U.S. Cl. CPC B01D 53/9468; B01D 53/52; B01J 23/44; B01J 23/42; B01J 20/06; B01J 20/041; F01N 3/085; F01N 3/0814; B01D 2251/304; B01D 2251/404; B01D 2251/402; B01D 2251/408; B01D 2255/1023; B01D 2255/1021

(57) ABSTRACT

A hydrocarbons removal system and methods and uses thereof are described. The hydrocarbons removal system can comprise at least one sulfur trap and an oxidation catalyst.

### CROSS-REFERENCE TO RELATED APPLICATIONS

This application claims priority under 35 U.S.C. 119 to U.S. Provisional Application No. 62/025,767, filed Jul. 17, 2014, the entire content of which is hereby incorporated by reference.

### FIELD

The present disclosure relates to the removal of total hydrocarbons, particularly alkanes, from the exhaust of gas powered internal combustion engines, and related methods and uses.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

The exhaust gas of lean burn gas engines contains significant amounts of unburned methane. Methane is known to be a powerful green house gas with about 20 times the greenhouse potential of carbon dioxide (CO₂). Palladium-based and/or platinum-based oxidation catalysts are often used to eliminate methane and non-methane hydrocarbons (NMHCs). However, these catalysts are extremely sensitive to sulfur poisoning from the trace amounts of sulfur already present in the gas.

Thus, there is a need for a more efficient method for the removal of methane and NMHCs, which avoids the problem of sulfur poisoning. This and other objectives will become apparent from the following description.

### SUMMARY

In an exemplary embodiment, a total hydrocarbons removal system comprises at least one sulfur trap and an oxidation catalyst. The sulfur trap comprises sodium, calcium, iron, magnesium, copper, manganese, aluminum, barium, or mixtures thereof. The oxidation catalyst comprises palladium, platinum, or mixtures thereof.

According to another exemplary embodiment a method for removing hydrocarbon species from a gas stream is provided. The method comprises the steps of:
(i) removing sulfur compounds (such as H₂S and mercaptans) from a fuel with a H₂S sorbent system to obtain a gas stream;
(ii) removing sulfur compounds (such as SO₂ and SO₃) from the gas stream with a sulfur trap to obtain a substantially sulfur free gas stream; and
(iii) oxidizing hydrocarbons from the substantially sulfur free gas stream with a catalyst.

According to yet another embodiment a method of extending the operating time of an oxidation catalyst is provided. The method comprises the steps of:
(i) removing sulfur compounds (such as H₂S and mercaptans) from a fuel with a H₂S sorbent system to obtain a gas stream;
(ii) removing sulfur compounds (such as SO₂ and SO₃) from the gas stream with a SOx sorbent system (a sulfur trap) to obtain a substantially sulfur free gas stream (such as an engine exhaust), wherein the sulfur trap comprises sodium, calcium, iron, magnesium, copper, manganese, aluminum, barium, or mixtures thereof; and
(iii) oxidizing hydrocarbons from the substantially sulfur free gas stream with a catalyst.

### BRIEF DESCRIPTION OF THE DRAWINGS

These and other features of this invention will now be described with reference to the drawings of certain embodiments, which are intended to illustrate and not to limit the invention.

FIG. 1 is a diagram of the methane removal efficiency over an oxidation catalyst from a gas stream comprising 0 ppm of SO₂ when compared to a fuel comprising 0.15 ppm of SO₂.

FIG. 2 is a diagram of the methane removal efficiency over a palladium-based oxidation catalyst from a gas stream comprising various amounts of sulfur compounds.

FIG. 3 is an illustration of an exemplary embodiment of a total hydrocarbon removal system.

FIG. 4 is an illustration of an exemplary embodiment of a total organic carbon removal system.

FIG. 5 is an illustration of an exemplary embodiment of a total organic carbon removal system housing.

FIG. 6 is an illustration of an exemplary embodiment of a complete aftertreatment system.

FIG. 7 is a diagram of the methane conversion over time.

### DETAILED DESCRIPTION OF THE PREFERRED EMBODIMENTS

Further aspects, features and advantages of this invention will become apparent from the detailed description, which follows.

As noted above, in its broader aspects, the embodiments are directed to a hydrocarbons removal system, a method for removing hydrocarbons from a source, and a method for extending the operating time of an oxidation catalyst.

Unless otherwise indicated, the term “total organic carbon” or “TOC” means the total hydrocarbons content of a gas stream such as an engine exhaust. The TOC can be measured by means and methods known to those having ordinary skill in the art. Additionally, the TOC can be expressed in concentration units commonly used in the art, for example, the TOC can be expressed as mg/m³, mg/Nm³, ppmv, g/kWh, g/bhp·h and mg/L.

Electric power generator, such as a gen-set, is used to generate electric power using biogas. The biogas can be from anaerobic digestion of a feedstock, such as corn, rice, animal fat, landfill, waste water sludge, etc. The raw engine exhaust that enters the aftertreatment system can comprise CO₂, SO₂, H₂O, nitrogen, NOx, and various other elements and compounds. In some European countries, the TOC target for biogas power plants is to reduce the TOC concentrations to less than 150 mg/Nm³ at the engine exhaust outlet. The European Union standards require to have a methane removal efficiency of greater than 80% to meet the TOC limits.

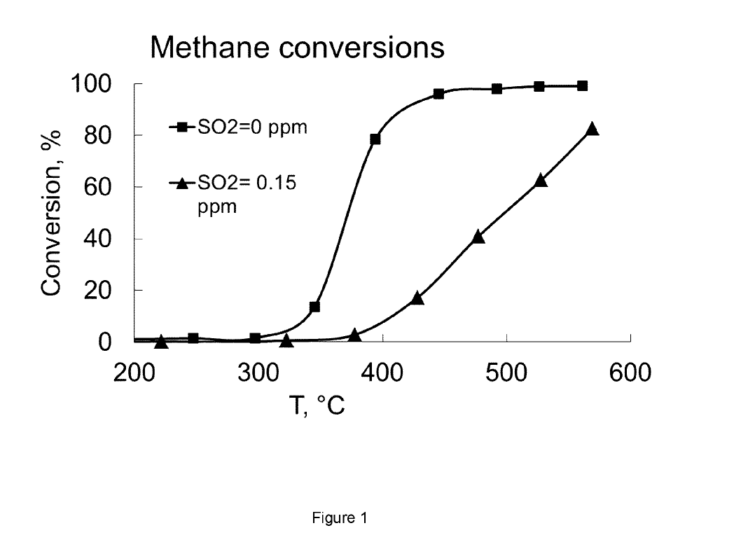

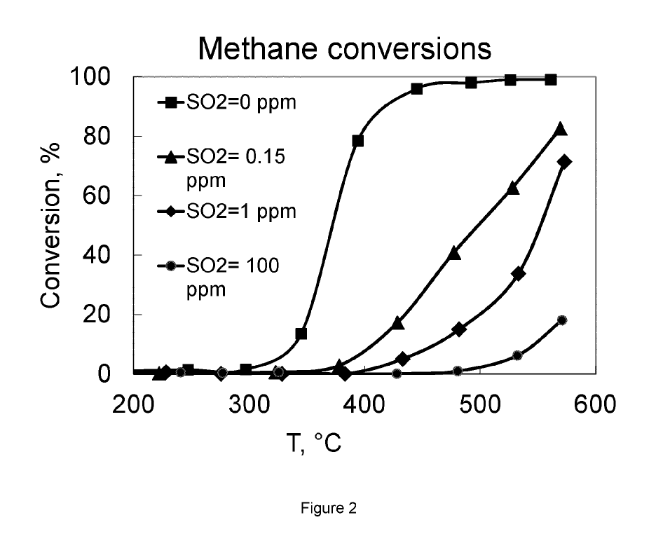

Palladium-based and/or platinum-based oxidation catalysts with high activity at low temperatures are often used to eliminate methane and non-methane hydrocarbons (NMHCs). As shown in FIG. 1, greater than 80% methane removal efficiency is achievable at temperatures 400° C. or higher, with gas streams that are free of sulfur dioxide. Trace amounts of sulfur dioxide, as low as 0.15 ppm, can significantly reduce the efficiency of the oxidation catalyst. As shown in FIG. 2, the reduction in oxidation efficiency is significantly reduced with an increase in sulfur dioxide concentration. Thus, it is necessary to remove sulfur before catalytic oxidation of methane and NMHCs.

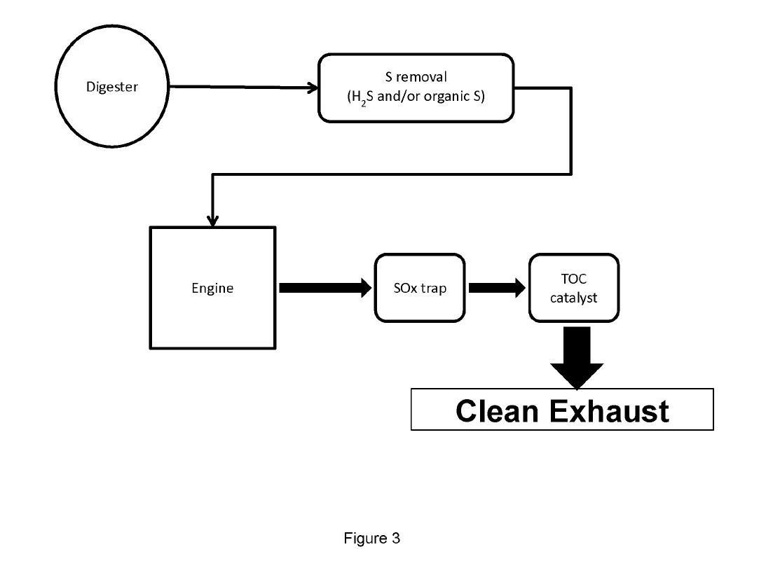

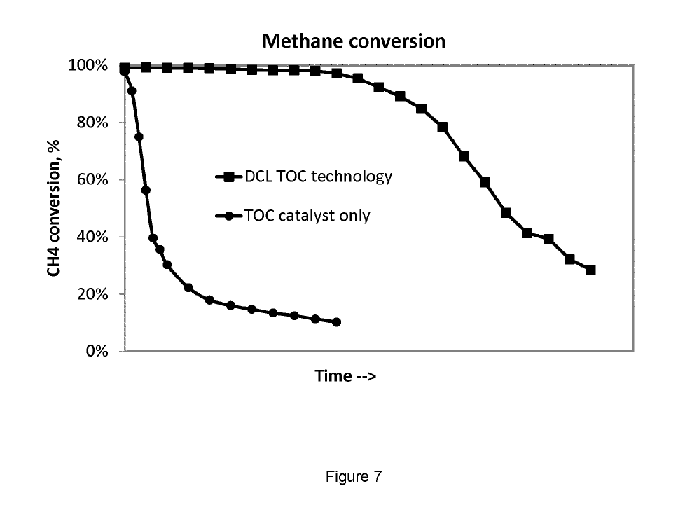

In an exemplary embodiment, biomass in solid and/or liquid form is converted into a biogas with a digester to produce a gas stream comprising methane, carbon dioxide, hydrogen sulfide (H₂S), and other organic sulfur compounds, such as mercaptans. (See FIG. 3.) The sulfur compounds in the biogas stream (or fuel) is firstly removed as H₂S and/or organic sulfur using a H₂S scrubber, so that the H₂S content of the biogas is less than 0.1 ppm. The biogas can then be sent to an engine to produce a gas stream, such as an engine exhaust. The resulting gas stream passes through a sulfur trap to remove SO₂ and SO₃ (SOx) from the gas stream. The resulting gas stream has a SOx concentration of nearly zero, such as less than 0.001 ppmv. The methane and NMHCs of the resulting gas stream is oxidized with a catalyst. As shown in FIG. 7, the removal of the sulfur prior to oxidation increases the operating time of the catalyst to nearly 50 times the operating time of bioconversion systems, which do not comprise a sulfur trap.

Exemplary embodiments of the hydrocarbons removal system comprise at least one sulfur trap and a catalyst. In a preferred embodiment, the catalyst comprises palladium, platinum, and mixtures thereof.

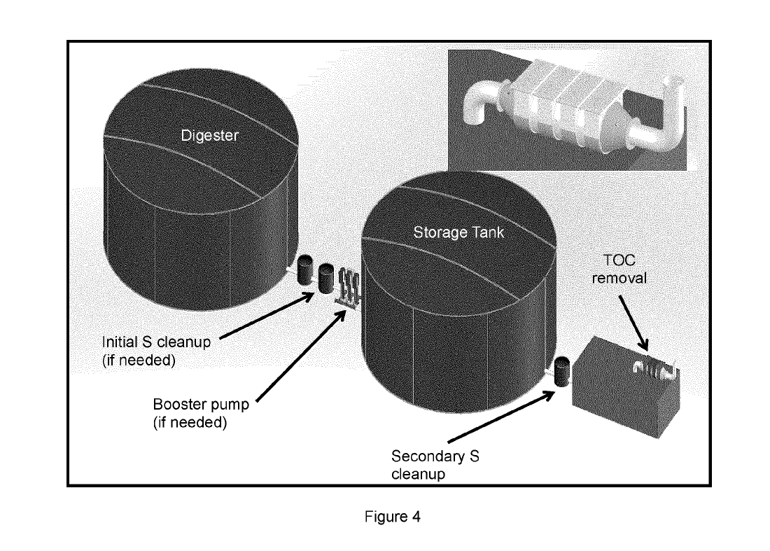

In an exemplary embodiment the sulfur trap is a single sulfur trap, and in another exemplary embodiment the sulfur trap is a series of sulfur trap and/or sulfur removal components. As shown in FIG. 4, in an alternative embodiment, the hydrocarbons removal system optionally comprises an initial sulfur cleanup (H₂S or organic S scrubber) followed by a booster pump to transport the biogas to a gas storage tank. The resulting biogas stream can then pass through a second sulfur cleanup (H₂S or organic S scrubber) after the storage tank before entering the gen-set. The methane and NMHCs in the engine exhaust are oxidized by the TOC removal system.

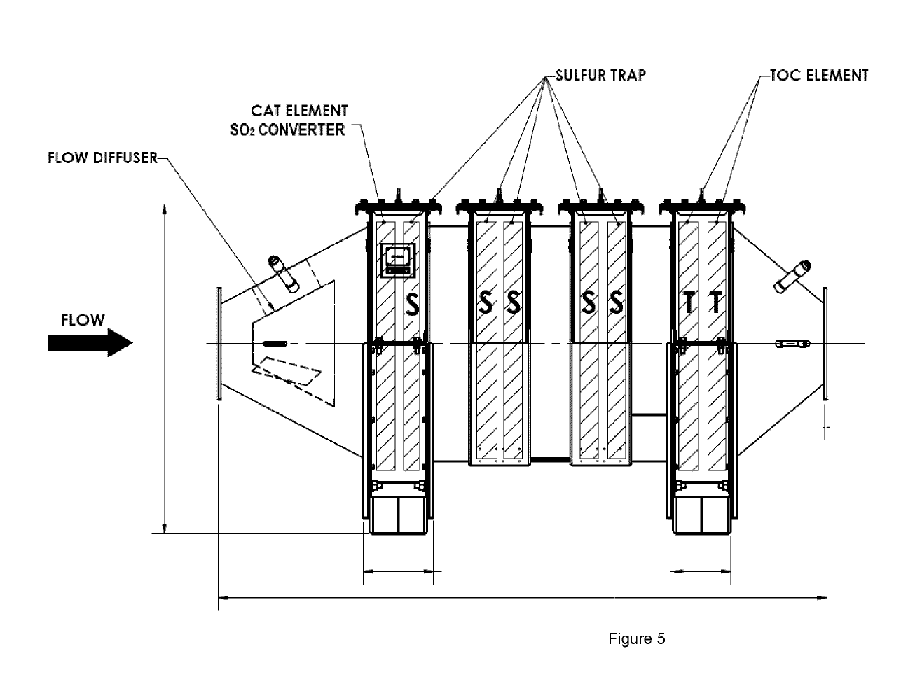

In an exemplary embodiment of the TOC removal system, at least one sulfur trap and the oxidation catalyst are in a housing unit as shown in FIG. 5. In another exemplary embodiment, the flow of the solution through the housing unit is regulated with a flow diffuser.

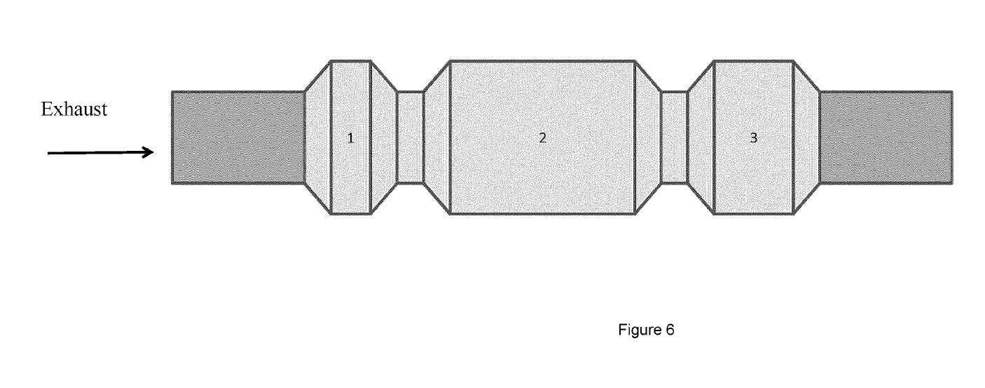

In an exemplary embodiment, the TOC removal system comprises three layers, as shown in FIG. 6. In a preferred embodiment, the first layer comprises an oxidation catalyst that converts SO₂ to SO₃; the second layer comprises a sulfur trap to absorb SO₂ and SO₃; and the third layer comprises a TOC catalyst.

In an exemplary embodiment the sulfur trap comprises sodium, calcium, iron, magnesium, copper, manganese, aluminum, barium, or mixtures thereof. In a preferred embodiment the sulfur trap comprises Fe₂O₃.H₂O, CaO, Na₂O, or mixtures thereof. In an exemplary embodiment SO₂ and SO₃ from the gas stream, such as raw engine exhaust, reacts with CaO to produce CaSO₃ and CaSO₄, respectively, which is absorbed by the sulfur trap. In another exemplary embodiment, SO₂ and SO₃ reacts with Na₂O produce Na₂SO₃ and Na₂SO₄, respectively, which is absorbed by the sulfur trap.

In a preferred embodiment, the TOC removal system has a methane removal efficiency of at least 80% for at least 4000 hours at temperatures of 400° C. or higher under engine exhaust conditions, which represents a total operation time of about 50 times greater than TOC removal systems that do not comprise the sulfur trap of the exemplary embodiments.

Exemplary embodiments also include a method for removing hydrocarbons from a gas stream, such as an engine exhaust. In one embodiment, the method for removing hydrocarbons from a gas stream, such as an engine exhaust, comprises the following steps:
(i) removing sulfur compounds (such as H₂S and mercaptans) from a fuel with a H₂S sorbent system to obtain a gas stream;
(ii) removing sulfur compounds (such as SO₂ and SO₃) from the gas stream with a SOx sorbent system (sulfur trap) to obtain a substantially sulfur free gas stream (such as an engine exhaust); and
(iii) oxidizing hydrocarbons from the substantially sulfur free engine exhaust with a oxidation catalyst.

The catalyst and the sulfur trap can be comprised of any materials known to those having ordinary skill in the art. In a preferred method, the catalyst comprises palladium, platinum, or a mixture thereof. In exemplary embodiments the catalyst has a methane removal efficiency of at least 80% at temperatures 400° C. or higher under engine exhaust conditions for at least 4000 hours.

In an exemplary embodiment, the sulfur trap comprises sodium, calcium, iron, magnesium, copper, manganese, aluminum, barium, or mixtures thereof. In a preferred embodiment, the sulfur trap comprises Fe₂O₃.H₂O, CaO and Na₂O. In an exemplary embodiment SO₂ and SO₃ from the gas stream reacts with CaO to produce CaSO₃ and CaSO₄, respectively, which is absorbed by the sulfur trap. In another exemplary embodiment, SO₂ and SO₃ reacts with Na₂O produce Na₂SO₃ and Na₂SO₄, respectively, which is absorbed by the sulfur trap.

In an alternative embodiment, the method comprises the steps of:
(i) removing sulfur compounds (such as H₂S and mercaptans) from an initial fuel to obtain a substantially gas stream fuel by:
   (a) removing S as H₂S and mercaptans from the initial fuel with a first H₂S sorbent system to obtain a substantially sulfur free fuel, and
   (b) removing H₂S and mercaptans from the gas storage tank with a second H₂S sorbent system to obtain a gas streaml;
(ii) removing sulfur compounds (such as SO₂ and SO₃) from the gas stream with a SOx sorbent system (sulfur trap) to obtain a substantially sulfur free gas stream; and
(iii) oxidizing hydrocarbons from the substantially sulfur free gas stream with a oxidation catalyst.

Exemplary methods can also include a method of extending the operating time of a TOC catalyst. In one embodiment, the method comprises the following steps:
(i) removing sulfur from a fuel with a H₂S sorbent system to obtain a substantially sulfur free fuel, wherein the H₂S sorbent system to obtain a gas stream (such as an engine exhaust);
(ii) removing sulfur compounds (such as SO₂ and SO₃) from the gas stream with a SOx sorbent system (sulfur trap) to obtain a substantially sulfur free gas stream, wherein the SOx sorbent system comprises sodium, calcium, iron, magnesium, copper, manganese, aluminum, barium, or mixtures thereof; and
(iii) oxidizing hydrocarbons from the substantially sulfur free gas stream with a catalyst.

The catalyst and the sulfur trap can be comprised of any materials known to those having ordinary skill in the art. In a preferred method, the catalyst comprises palladium, platinum, or a mixture thereof. In exemplary embodiments the catalyst has a methane removal efficiency of at least 80% under the engine exhaust conditions at temperature 400° C. or higher for at least 4000 hours. Accordingly, the operating time of the catalyst is about 50 times longer than the operating time of a TOC method without the sulfur removal step (ii).

In a preferred embodiment, the sulfur trap comprises Fe₂O₃.H₂O, CaO and Na₂O. In an exemplary embodiment SO₂ and SO₃ from the gas stream (such as an engine exhaust) reacts with CaO to produce CaSO₃ and CaSO₄, respectively, which is absorbed by the sulfur trap. In another exemplary embodiment, SO₂ and SO₃ reacts with Na₂O to produce Na₂SO₃ and Na₂SO₄, respectively, which is absorbed by the sulfur trap.

In an alternative embodiment, the method comprises the steps of:
(i) removing sulfur compounds (such as H₂S and mercaptans) from a fuel with a H₂S sorbent system to obtain a gas stream, wherein the H₂S sorbent system comprises sodium, calcium, iron, magnesium, copper, manganese, aluminum, barium, or mixtures thereof by:
   (a) removing sulfur compounds as H₂S and/or mercaptans from an initial fuel with a first H₂S sorbent system to obtain an intermediate fuel that could optionally be sent to a storage tank, and
   (b) removing H₂S, mercaptans, other organic sulfur compounds, or mixtures thereof from the fuel after storage tank to obtain a gas stream (such as an engine exhaust);
(ii) removing sulfur compounds (such as SO₂ and SO₃) from the gas stream with a SOx sorbent system (sulfur trap) to obtain a substantially sulfur free gas stream (such as an engine exhaust), wherein the SOx sorbent system comprises sodium, calcium, iron, magnesium, copper, manganese, aluminum, barium, or mixtures thereof; and
(iii) oxidizing hydrocarbons from the substantially sulfur free gas stream with a catalyst.

The systems and methods described herein are intended to encompass the components and steps, which consist of, consist essentially of, as well as comprise, the various constituents identified herein, unless explicitly indicated to the contrary.

Any numbers expressing quantities of ingredients, constituents, reaction conditions, and so forth used in the specification are to be understood as being modified in all instances by the term “about.” Notwithstanding that the numeric ranges and parameters setting forth, the broad scope of the subject matter presented herein are approximations, the numerical values set forth are indicated as precisely as possible. Any numerical value, however, may inherently contain certain errors or inaccuracies as evident from the standard deviation found in their respective measurement techniques. None of the features recited herein should be interpreted as invoking 35 U.S.C. §112(f), unless the terms “means” is explicitly used.

It is to be understood that the exemplary embodiments described herein are merely illustrative of the application of the principles of the claimed system and methods. Reference herein to details of the illustrated embodiments is not intended to limit the scope of the claims. It will be appreciated by those skilled in the art that additions, deletions, modifications, and substitutions not specifically described may be made without departing from the spirit and scope of the exemplary embodiments.

What is claimed is:

1. A hydrocarbons removal system comprising at least one sulfur trap and a catalyst.

2. The hydrocarbons removal system according to claim 1, wherein the catalyst comprises palladium, platinum, or a mixture thereof.

3. The hydrocarbons removal system according to claim 1, wherein the sulfur trap comprises sodium, calcium, iron, magnesium, copper, manganese, aluminum, barium, or mixtures thereof.

4. The hydrocarbons removal system according to claim 3, wherein the sulfur trap comprises Fe₂O₃.H₂O, CaO and Na₂O.

5. The carbon removal system according to claim 1, wherein the catalyst has a methane removal efficiency of at least 80%.

6. The carbon removal system according to claim 1, wherein the catalyst has a methane removal efficiency of at least 80% for at least 4000 hours.

7. A method for removing hydrocarbons from a gas stream, the method comprising the steps of:
(i) removing sulfur compounds from a fuel with a H₂S sorbent system to obtain a gas stream;
(ii) removing sulfur from the gas stream with a SOx sorbent system (a sulfur trap) to obtain a substantially sulfur free gas stream; and
(iii) oxidizing hydrocarbons from the substantially sulfur free gas stream with a catalyst.

8. The method according to claim 7, wherein the catalyst comprises palladium, platinum, or a mixture thereof.

9. The method according to claim 7, wherein the sulfur trap comprises sodium, calcium, iron, magnesium, copper, manganese, aluminum, barium, or mixtures thereof.

10. The method according to claim 7, wherein the sulfur trap comprises Fe₂O₃.H₂O, CaO and/or Na₂O.

11. The method according to claim 7, wherein the catalyst has a methane removal efficiency of at least 80%.

12. The method according to claim 7, wherein the catalyst has a methane removal efficiency at least 80% for at least 4000 hours.

13. The method according to claim 7, wherein step (i) comprises:
(a) removing sulfur as H₂S and/or mercaptans with a first H₂S sorbent system from an initial fuel to obtain an intermediate fuel; and
(b) removing sulfur as H₂S, mercaptans, other organic sulfur compounds, or mixtures thereof from the intermediate fuel with a second H₂S sorbent system to obtain a gas stream comprising trace amounts of sulfur.

14. A method of extending an operating time of a catalyst, the method comprising the sequential steps of:
(i) removing sulfur compounds from a fuel with a H₂S sorbent system to obtain a gas stream;
(ii) removing sulfur compounds from the gas stream with a SOx sorbent system (a sulfur trap) to obtain a substantially sulfur free gas stream, wherein the sulfur trap comprises sodium, calcium, iron, magnesium, copper, manganese, aluminum, barium, or mixtures thereof; and
(iii) oxidizing hydrocarbons from the substantially sulfur free engine exhaust with a catalyst.

15. The method according to claim 14, wherein the catalyst comprises palladium, platinum, or a mixture thereof.

16. The method according to claim 14, wherein the catalyst has a methane removal efficiency of at least 80%.

17. The method according to claim 14, wherein the catalyst has a methane removal efficiency of at least 80% for at least 4000 hours.

18. The method according to claim 14, wherein step (i) comprises:
(a) removing sulfur as H₂S and/or mercaptans with a first H₂S sorbent system from an initial fuel to obtain an intermediate fuel; and
(b) removing sulfur as H₂S, mercaptans, other organic sulfur compounds, or mixtures thereof from the intermediate fuel with a second H₂S sorbent trap to obtain a gas stream comprising trace amounts of sulfur.

19. The method according to claim 14, wherein the sulfur in step (i) is removed as H₂S, mercaptans, or mixtures thereof; and the sulfur in step (ii) is removed as SO₂, SO₃, and mixtures thereof.

20. The method according to claim 14, wherein the catalyst has an operating time that is 50 times longer than an operating time without the sulfur removal steps (i) and (ii).
